(19) United States
(12) Patent Application Publication
(10) Pub. No.: US 2023/0077601 A1
(43) Pub. Date: Mar. 16, 2023

(54) WATER LAMP WITH TOP ORNAMENT

(71) Applicant: CHIN-SHENG YANG, Tainan City (TW)

(72) Inventor: CHIN-SHENG YANG, Tainan City (TW)

(21) Appl. No.: 17/471,171

(22) Filed: Sep. 10, 2021

(51) Int. Cl. F21V 9/00; F21S 6/00; F21V 17/10

(52) U.S. Cl. CPC F21V 9/00; F21S 6/002; F21V 17/10; F21W 2121/008

(57) ABSTRACT

A water lamp with a top ornament, including: a water lamp body, being a hollow and light-transmissive three-dimensional structure and holds a thick liquid inside; a base being arranged under the water lamp body, and a control circuit is arranged in the base; and a top ornament, where the top ornament is arranged on the water lamp body, at least one light-emitting element is arranged inside the top ornament, the light-emitting element is electrically connected to the control circuit, and the top ornament is further provided with at least one light-transmissive projection member. In the present application, the light-emitting element is arranged in the top ornament, and the top of the top ornament is provided with the transmissive hole or/and the insertion hole. The transparent film covered with the customized patterns is bonded at the transmissive hole, and the customized ornament is inserted in the insertion hole.

### BACKGROUND

### Technical Field

The present application relates to the field of handicrafts technologies, and in particular, to a water lamp with a top ornament.

### Related Art

In daily life, some handicraft decorations are often placed on indoor desktops and cabinets. Such decorations are usually photo frames, toys, and figures, and only have a static ornamental function. Therefore, a crystal lamp decoration with sequins, glitter or decorations is designed in the current market, which uses manually inverted shaking or electric power to produce a visually fluid movement with the sequins, glitter or decorations inside the crystal lamp.

However, for this type of handicraft decorations, various designs and changes are limited to the crystal ball. Therefore, the development of this type of handicraft decorations is also limited. The applicant of this application has long been engaged in manufacturing this type of decorations, and has filed an application for the U.S. Pat. No. 9,222,663 B1 which was approved recently, to provide this type of decorations with various visual changes and facilitate manufacturing. Therefore, if the above-mentioned handicraft decorations are combined with various lighting effects, the fun effects or visual effects of such handicraft decorations can be greatly improved, which surely will make the handicraft decorations more popular with the public.

### SUMMARY

The objective of the present application is to provide a water lamp with a top ornament with different visual experiences and a better viewing effect.

In order to solve the above-mentioned technical problem, the present application may be implemented by using the following technical solutions:

A water lamp with a top ornament comprises: a water lamp body, where the water lamp body is a hollow and light-transmissive three-dimensional structure and holds a thick liquid inside;

a base, where the base is arranged under the water lamp body, and a control circuit is arranged in the base; and

a top ornament, where the top ornament is arranged on the water lamp body, at least one light-emitting element is arranged inside the top ornament, the light-emitting element is electrically connected to the control circuit, and the top ornament is further provided with at least one light-transmissive projection member.

In an embodiment, the light-transmissive projection member is provided with at least one light-transmissive hole.

In an embodiment, the light-transmissive projection member is provided with an insertion hole, an ornament is inserted in the insertion hole, and the ornament is made of a light-transmissive material.

In an embodiment, the light-transmissive projection member is provided with at least one light-transmissive hole and an insertion hole, an ornament is inserted in the insertion hole, and the ornament is made of a light-transmissive material.

In an embodiment, a transparent film covered with customized patterns is bonded at the light-transmissive hole.

In an embodiment, a magnetic rotating member is arranged at the bottom in the water lamp body, a magnetic driving member is arranged in the base and is electrically connected to the control circuit, and the magnetic driving member drives the magnetic rotating member to rotate.

The beneficial effects of the present application are as follows: In the water lamp with a top ornament of the present application, the light-emitting element is arranged in the top ornament, and the top of the top ornament is provided with the transmissive hole or/and the insertion hole. The transparent film covered with the customized patterns is bonded at the transmissive hole, and the customized ornament is inserted in the insertion hole. In this way, light of different patterns may be projected through the transparent film and the transmissive hole. In addition, the light of the light-emitting element may also illuminate the ornament through the insertion hole to enable the ornament to shine. Finally, the water lamp with a top ornament may produce different visual experiences and a better viewing effect.

### BRIEF DESCRIPTION OF THE DRAWINGS

FIG. 1 is a schematic structural diagram of Embodiment 1 of a water lamp with a top ornament according to the present application;

FIG. 2 is a schematic structural diagram of a top ornament of Embodiment 1 of a water lamp with a top ornament according to the present application;

FIG. 3 is a cross-sectional view of a top ornament of Embodiment 1 of a water lamp with a top ornament according to the present application;

FIG. 4 is a schematic structural diagram of Embodiment 2 of a water lamp with a top ornament of the present application;

FIG. 5 is a schematic structural diagram of a top ornament of Embodiment 2 of a water lamp with a top ornament according to the present application;

FIG. 6 is a cross-sectional view of a top ornament of Embodiment 2 of a water lamp with a top ornament according to the present application;

FIG. 7 is a schematic structural diagram of Embodiment 3 of a water lamp with a top ornament according to the present application;

FIG. 8 is a schematic structural diagram of a top ornament of Embodiment 3 of a water lamp with a top ornament according to the present application; and

FIG. 9 is a cross-sectional view of a top ornament of Embodiment 3 of a water lamp with a top ornament according to the present application.

As shown in the drawings: 100. water lamp body; 110. magnetic rotating member; 200. base; 210. magnetic driving member; 300. top ornament; 400. light-emitting element; 500, light-transmissive projection member; 510. transmissive hole; 511. transparent film; 520. insertion hole; and 521. ornament.

### DETAILED DESCRIPTION

To make the foregoing objects, features and advantages of the present application more comprehensible, detailed description is made to specific implementations of the present application below with reference to the accompanying drawings. In the following description, many specific details are described to give a full understanding of the present application. However, the present application may be implemented in many other manners different from those described herein. A person skilled in the art may make similar improvements without departing from the connotation of the present application. Therefore, the present application is not limited to the specific embodiments disclosed below.

It is to be noted that, when a component is referred to as “being fixed to” another component, the component may be directly on the other component, or an intervening component may be present. When a component is considered to be “connected to” another component, the component may be directly connected to the another component, or an intervening component may also be present. In contrast, when a component is referred to as being “directly on” or “directly connected to” another component, there is no intervening component. The terms “vertical”, “horizontal”, “left”, and “right” and similar expressions used in this specification are merely used for the purpose of description.

Unless otherwise defined, meanings of all technical and scientific terms used in this specification are the same as those usually understood by a person skilled in the art to which the present application belongs. In this specification, terms used in the specification of the present application are merely intended to describe objectives of the specific embodiments, but are not intended to limit the present application. The term “and/or” used in this specification includes any and all combinations of one or more related listed items.

### Embodiment 1

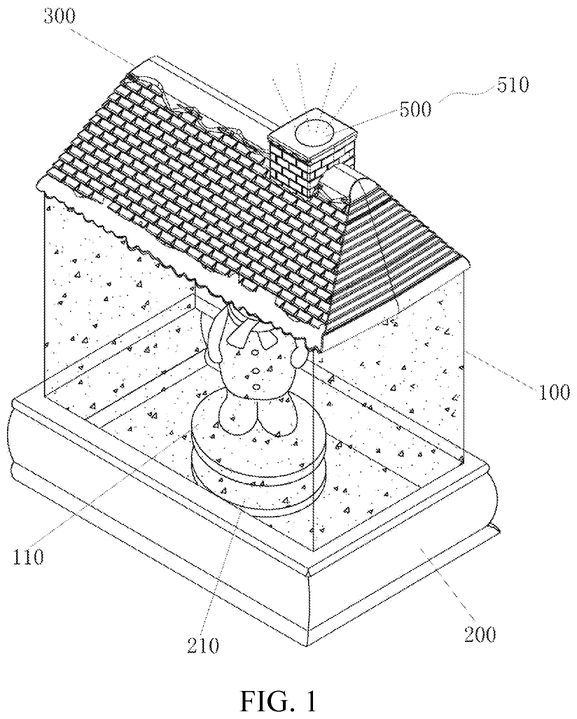

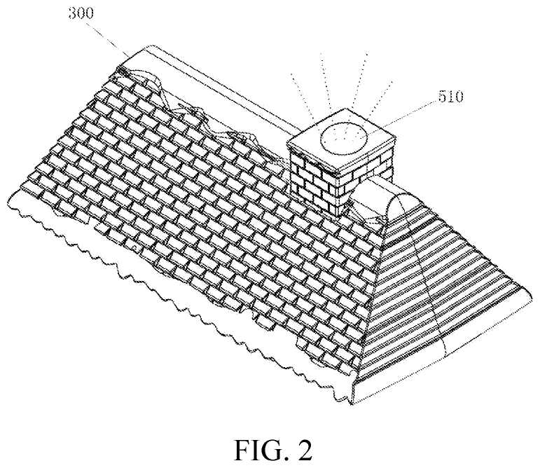

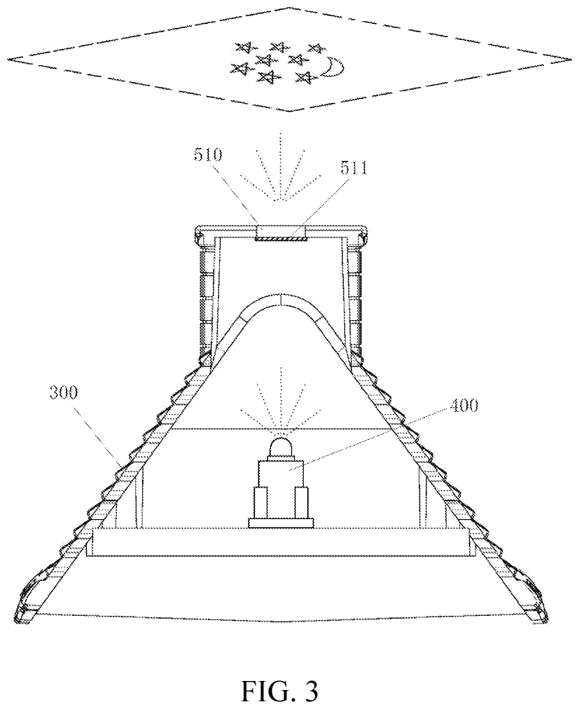

Referring to FIG. 1 to FIG. 3, a water lamp with a top ornament includes: a water lamp body 100, where the water lamp body 100 is a hollow and light-transmissive three-dimensional structure and holds a thick liquid inside; a base 200, where the base 200 is arranged under the water lamp body 100, and a control circuit (not shown in the figure) is arranged in the base 200; and a top ornament 300, where the top ornament 300 is arranged on the water lamp body 100, at least one light-emitting element 400 is arranged inside the top ornament 300, the light-emitting element 400 is electrically connected to the control circuit, and the top ornament 300 is further provided with at least one light-transmissive projection member 500.

Specifically, in this embodiment, the water lamp with a top ornament includes the water lamp body 100, the base 200 is arranged under the water lamp body 100, and the top ornament 300 is arranged on the water lamp body. The base 200 and the top ornament 300 may be designed into various shapes to achieve different visual experiences. In addition, the inside of the water lamp body 100 is further sealed with a thick liquid and may be provided with an interior view, which can also improve the visual experience. To enable the water lamp to emit light, the control circuit is arranged in the base 200, and at least one light-emitting element 400 is arranged in the top ornament 300. The control circuit and the light-emitting element 400 are respectively connected by wires. The wires are fixed on an outer wall of the water lamp body 100. The control circuit may control the light-emitting element 400 to emit light of different colors, and may also enable the light emitted by the light-emitting element 400 to flicker, to improve a visual effect.

Moreover, in this embodiment, the light-transmissive projection member 500 is provided with at least one light-transmissive hole 510, and the light emitted by the light-emitting element 400 is projected out through the transmissive hole 510. To enable the light projected by the transmissive hole 510 to bring a better visual experience, a transparent film 511 covered with customized patterns is bonded at the transmissive hole 510, and light of various patterns may be projected through the transparent film 511 covered with patterns. Finally, a visual experience is improved and a better viewing effect is achieved.

Finally, in this embodiment, a magnetic rotating member 110 is arranged at the bottom of the water lamp body 100. A magnetic driving member 210 is arranged in the base 200, and is electrically connected to the control circuit. The magnetic driving member 210 drives the magnetic rotating member 110 to rotate.

In this embodiment, glitter may be arranged in the liquid inside the water lamp body 100, and an internal scene of the water lamp body 100 may be connected to the magnetic rotating member 110. When rotating, the magnetic rotating member 110 drives the liquid inside the water lamp body 100 to flow, so that the glitter also flows, and the interior scene is also driven by the magnetic rotating member 110 to rotate. Finally, the light emitted through the transparent film 511 and the transmissive hole 510 is combined to improve the visual experience and the viewing effect of the water lamp with a top ornament.

### Embodiment 2

In this embodiment, a water lamp with a top ornament is basically the same as that in Embodiment 1, and a main difference is that: a light-transmissive projection member 500 is provided with an insertion hole 520, an ornament 521 is inserted in the insertion hole 520, and the ornament 521 is made of a light-transmissive material.

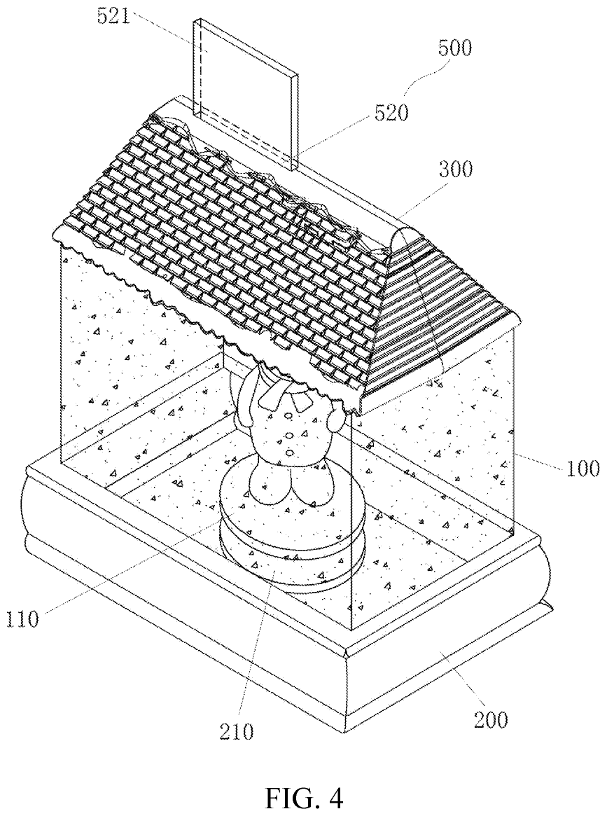

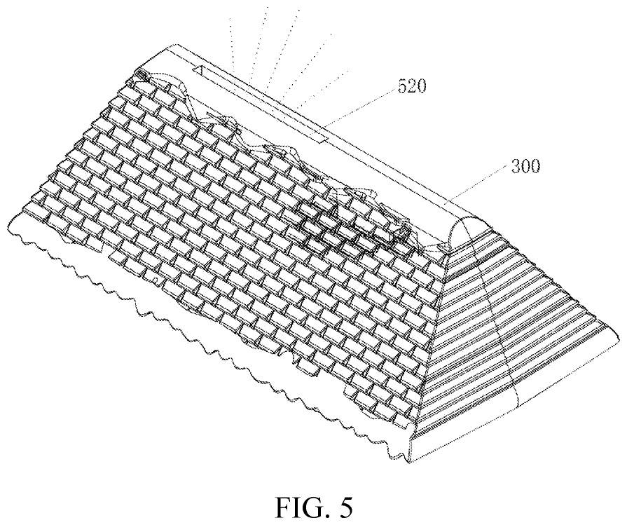

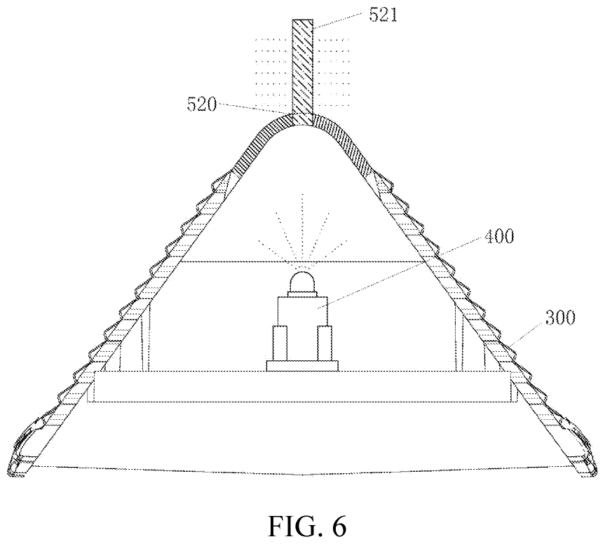

Specifically, referring to FIG. 4 to FIG. 6, in this embodiment, to improve a visual experience, the light-transmissive projection member 500 is connected to the insertion hole 520 provided at the top of a top ornament 300, and the bottom of the ornament 521 may be directly inserted in the insertion hole 520 in an interference fit. In this way, the ornament 521 may be replaced at any time, so that the inserted ornament 521 may be diversified, thereby improving a viewing effect, and the ornament 521 is stable after being inserted and is not prone to tilt. In addition, in this embodiment, because the ornament 521 is made of a light-transmissive material, when the light-emitting element 400 emits light, the light may be projected to the ornament 521 through the insertion hole 520, to enable the entire ornament 521 to shine. Finally, the visual experience of the water lamp in this embodiment is improved, and the viewing effect of the water lamp with a top ornament is improved.

### Embodiment 3

In this embodiment, a water lamp with a top ornament is basically the same as that in the above-mentioned embodiments, and a main difference is that: a light-transmissive projection member 500 is provided with at least one transmissive hole 510 and an insertion hole 520, an ornament 521 is inserted in the insertion hole 520, and the ornament 521 is made of a light-transmissive material.

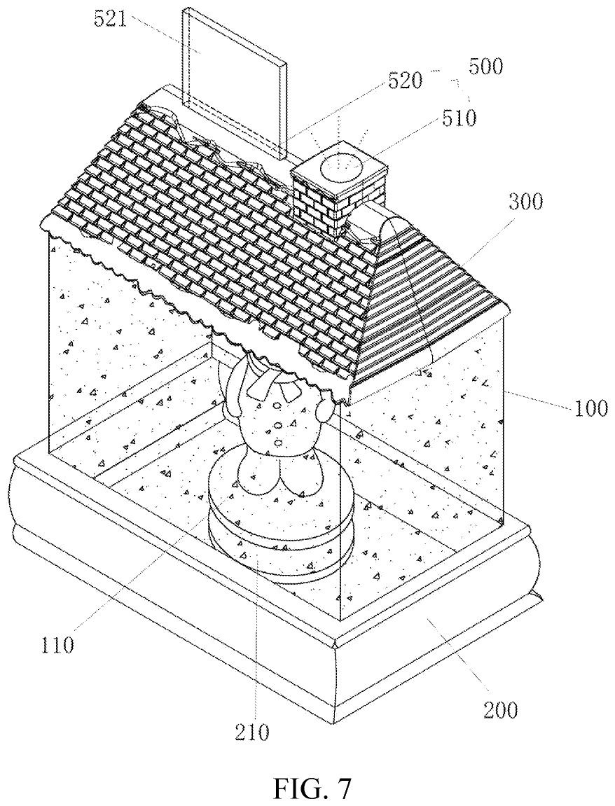

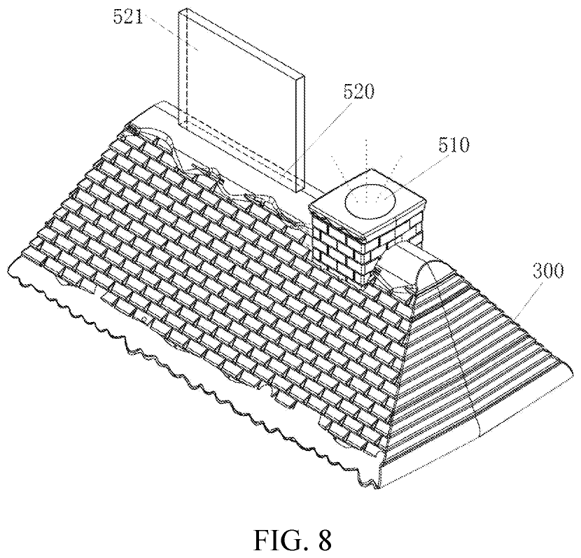

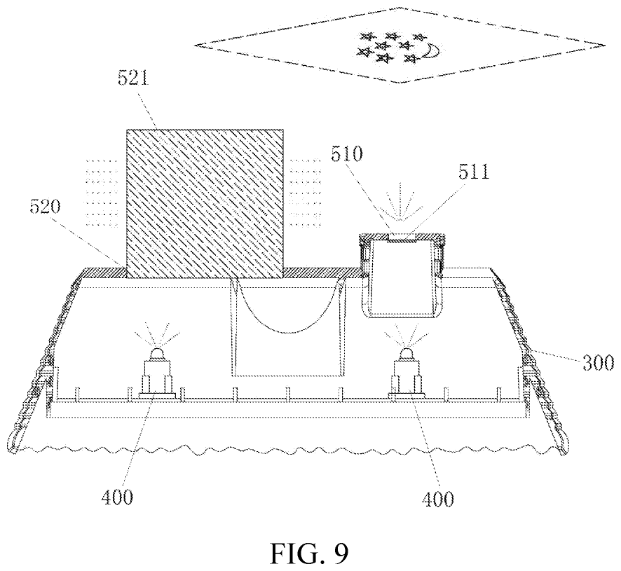

Specifically, referring to FIG. 7 to FIG. 9, in this embodiment, to make the viewing effect of the water lamp better, at least one transmissive hole 510 and the insertion hole 520 are both provided at the top of a top ornament 300. Similarly, a transparent film 511 covered with customized patterns is attached to the transmissive hole 510, and the light-transmissive ornament 521 is inserted in the insertion hole 520. When the light-emitting element 400 in the top ornament 300 emits light, the light of the light-emitting element may project light of various patterns through the transparent film 511 covered with patterns and the transmissive hole 510. Finally, a visual experience is improved and a better viewing effect is achieved. In addition, because the ornament 521 is made of a light-transmissive material, when the light-emitting element 400 emits light, the light of the light-emitting element may be projected to the ornament 521 through the insertion hole 520, to enable the entire ornament 521 to shine. Finally, the transmissive hole 510, the transparent film 511, the insertion hole 520, and the ornament 521 are combined to improve the visual experience and the viewing effect of the water lamp with a top ornament.

The foregoing shows and describes basic principles, main features of the present application and advantages of the present application. A person skilled in the art may smoothly implement this application according to the accompanying drawings and the foregoing descriptions of this specification. However, a person skilled in the art may make some equivalent variations such as alterations, modifications, and evolutions by using the disclosed technical content without departing from the scope of the technical solution of this application, and such equivalent variations are all equivalent embodiments of this application. Meanwhile, any equivalent variations such as alterations, modifications, and evolutions made to the foregoing embodiments according to the technical essence of this application shall still fall within the protection scope of the technical solution of this application.

1. A water lamp with a top ornament, comprising:
a water lamp body, wherein the water lamp body is a hollow and light-transmissive three-dimensional structure and holds a thick liquid inside;
a base, wherein the base is arranged under the water lamp body, and a control circuit is arranged in the base; and
a top ornament, wherein the top ornament is arranged on the water lamp body, at least one light-emitting element is arranged inside the top ornament, the light-emitting element is electrically connected to the control circuit, and the top ornament is further provided with at least one light-transmissive projection member;
wherein the light-transmissive projection member is provided with at least one light-transmissive hole and an insertion hole, an ornament is inserted in the insertion hole, and the ornament is made of a light-transmissive material.

2. The water lamp with a top ornament according to claim 1, wherein the light-transmissive projection member is provided with at least one light-transmissive hole.

3. The water lamp with a top ornament according to claim 1, wherein the light-transmissive projection member is provided with an insertion hole, an ornament is inserted in the insertion hole, and the ornament is made of a light-transmissive material.

4. (canceled)

5. The water lamp with a top ornament according to claim 1, wherein a transparent film covered with customized patterns is bonded at a light-transmissive hole.

6. The water lamp with a top ornament according to claim 4, wherein a transparent film covered with customized patterns is bonded at the light-transmissive hole.

7. The water lamp with a top ornament according to claim 1, wherein a magnetic rotating member is arranged at the bottom in the water lamp body, a magnetic driving member is arranged in the base and is electrically connected to the control circuit, and the magnetic driving member drives the magnetic rotating member to rotate.
